(19) United States
(12) Patent Application Publication
(10) Pub. No.: US 2017/0258075 A1
(43) Pub. Date: Sep. 14, 2017

(54) APPARATUS AND METHOD FOR STORING TISSUE

(71) Applicants: VIRGIN HEALTH BAK QSTP-LLC, Doha (QA); QATA FOUNDATON FOR EDUCATION,SCIENCE AND COMMUNITY DEVELOPMENT, Washington, DC (US)

(72) Inventors: Chris GOODMAN, Doha (QA); Kourosh SAEB-PARSY, Cambridge (GB)

(21) Appl. No.: 15/528,504

(22) PCT Filed: Nov. 20, 2015
(86) PCT No.: PCT/US2015/062007

§ 371 Date: May 20, 2017

(30) Foreign Application Priority Data
Nov. 21, 2014 (GB) 1420759.1

(51) Int. Cl. A01N 1/02

(52) U.S. Cl. CPC A01N 1/0268

(57) ABSTRACT

An apparatus (300) for storing body tissue (306) cryogenically comprising a plurality of storage units (350), each storage unit (350) comprising a cavity (352) configured to receive a portion of body tissue (306), wherein at least one storage unit (350) is detachably connected to at least one other storage unit (350).

### TECHNICAL FIELD

The invention relates to an apparatus and method for storing body tissue, particularly an apparatus and method for storing body tissue cryogenically.

### BACKGROUND ART

Umbilical cord blood is well-known to contain haematopoietic stem cells (“HSCs”), and it is known to harvest cord blood from an umbilical cord shortly after birth and to store the cord blood (and HSCs therein)—typically cryogenically—for therapeutic use at a later stage. In recent years, umbilical cord tissue has also been identified as a rich source of stem cells. Mesenchymal stem cells (“MSCs”) are present in the cord tissue—in and on the umbilical cord vein, the umbilical cord arteries and in the Wharton's jelly, notably in the perivascular Wharton's jelly. MSCs have emerged as major candidates in the field of cell-based therapies, particularly in regenerative medicine, and it is desirable to store MSCs for later use by the donor, family member or other allogeneic recipient. Accordingly, improved devices and methods for processing and storing umbilical cords, to enable access to viable stem cells when required, have become highly desirable.

The therapeutic potential of umbilical cord-derived MSCs is discussed in Dalous et al, Pediatric Research (2012) 71, 482-490. Typically, MSCs are obtained from the umbilical cord by dissecting the cord into small pieces and enzymatically digesting these pieces, typically with collagenase alone or in combination with trypsin and hyaluronidase. The isolated stem cells are then stored for later use.

WO-A-2011/073388 describes a method of separating the umbilical vascular tissue from the Wharton's jelly, followed by the separation of dissociated (stem) cells from the jelly matrix and the independent separation of stem cells from the vascular tissue, and cryopreservation of each population of separated dissociated cells.

There is currently no standardised procedure for extracting stem cells from umbilical cord tissue. Therefore, it may be advantageous to store whole umbilical cord tissue so that the stem cells may be extracted at a later stage. The current approach to storing whole tissue in this way is to bathe, soak or immerse the tissue in a dimethyl sulfoxide (DMSO) solution (5-30% v/v, typically 10% v/v) containing human serum albumin (HSA) or Fetal Bovine Serum (FBS) at 4° C. for approximately 40 to 90 minutes, and then preserve the tissue cryogenically. An example of this technique is described in WO-A-2007/071048.

Currently, whole umbilical tissue from a particular source (i.e. a particular person) is stored either as “private” tissue or “community” tissue. Private tissue is stored for use solely by the person who was the source of the tissue (the donor) or by another person with the permission of the donor or the donor's guardian or family. Community tissue is stored for use by one or more third parties (who are unconnected to the donor); in other words, community tissue is effectively donated upon storage.

However, current apparatuses and methods for storing whole umbilical cord tissue are inflexible and lack robustness. There exists a need for an apparatus and method which allows stored tissue to be used as and when it is required for any one of a number of uses (e.g. private/community). The present invention solves this and other problems.

### DISCLOSURE OF INVENTION

The inventors have devised an improved apparatus and method for storing biological tissue containing stem cells, particularly umbilical cord tissue. The tissue is typically stored cryogenically. The apparatus and method of the present invention have the advantage that a portion of the stored tissue can be removed from storage (e.g. cryogenic storage) and used for a particular purpose (e.g. private/community use) whilst the remaining tissue remains in storage until it is required. This means that the stored tissue, which is highly valuable, can be stored and used flexibly and efficiently. Moreover, since methods for preparing tissue for cryogenic storage and extracting stem cells from biological tissue, in particular, are continually being improved, the fact that a particular portion of tissue containing stem cells can be stored cryogenically, for example, until it is required means that the best possible methods of preparation and extraction can be employed. This optimises the post-thaw yield of stem cells from the stored tissue.

In accordance with a first aspect of the present invention, there is provided an apparatus for storing body tissue comprising a plurality of storage units, each storage unit comprising a cavity configured to receive a portion of body tissue, wherein at least one storage unit is detachably connected to at least one other storage unit. The detachable connection between storage units which are each configured to receive tissue means that a chosen amount of tissue can be detached and removed from storage whilst the remaining tissue is kept in storage.

At least one storage unit may comprise a seal for sealing the cavity. For example, each storage unit may comprise a seal for sealing its cavity. Such seals are advantageous because they can ensure sterility within the storage unit.

At least one storage unit may be connected to at least one other storage unit via at least one of a weakened portion, a perforated portion, a frangible connection and/or a snap-fit connection.

At least one storage unit may comprise an indicator comprising information about the contents of its cavity. The seal may comprise the indicator. Such indicators are advantageous because they allow the contents of the storage unit to be identified without the need to open the storage unit and expose the contents to the surrounding environment.

The storage units are arranged in a strip (i.e. a one-dimensional array). Alternatively, the storage units may be arranged in a two-dimensional array. The storage units may be rearrangable and/or reconfigurable. This further increases the flexibility and robustness of the apparatus. For example, the storage units can be continually rearranged to make the units more accessible and to make optimal use of the available space. The cavities may extend substantially in the same direction.

At least one seal or each seal may comprise a pull tab. Alternatively or additionally, at least one seal or each seal may comprise a cork, bung, lid or cap. At least one seal or each seal may be attachable to the cavity by an interference fit or by a screw thread. This can improve the strength of the connection between the seal and the storage unit.

The apparatus is for storing body tissue cryogenically. The apparatus may further comprise a cryogenic freezer in thermal communication with the storage units and configured to cryogenically freeze the contents of the storage units.

In accordance with another aspect of the present invention, there is provided an apparatus for storing body tissue, comprising:
a storage unit comprising a cavity configured to receive a portion of body tissue; and
a separator for dividing the cavity into a plurality of chambers.

The separator may be movable between an inactive position in which the separator does not divide the cavity into a plurality of chambers and an active position in which the separator divides the cavity into a plurality of chambers. The separator may comprise a wall or a slider, and may comprise a cutting edge. Therefore, the separator itself can be capable of dividing the tissue within the storage unit.

The separator may be configured to divide body tissue within the cavity into a plurality of pieces. The separator may be movable between a plurality of inactive positions whilst the separator is in its inactive configuration such that relative sizes of the plurality of chambers can be selected. This increases the flexibility of the apparatus.

The separator may comprise a sealing strip. The sealing strip may be configured to divide the cavity into a plurality of chambers via a press and seal mechanism.

The separator may form a detachable connection. Therefore, a portion of the storage unit and its contents can be detached for use whilst the remainder of the storage unit and its contents can remain in storage. The storage unit may comprise a plurality of separators.

The storage unit may comprise a seal for sealing the cavity. The storage unit may comprise an indicator comprising information about the contents of its cavity. The seal may comprise the indicator. Such indicators are advantageous because they allow the contents of the storage unit to be identified without the need to open the storage unit and expose the contents to the surrounding environment.

The apparatus may comprise a plurality of said storage units, wherein at least one storage unit may be detachably connected to at least one other storage unit. At least one storage unit may be connected to at least one other storage unit via at least one of a weakened portion, a perforated portion, a frangible connection and/or a snap-fit connection. The detachable connection between storage units which are each configured to receive tissue means that a chosen amount of tissue can be detached and removed from storage whilst the remaining tissue is kept in storage.

The storage units may be arranged in a strip (i.e. a one-dimensional array). Alternatively, the storage units may be arranged in a two-dimensional array. The storage units may rearrangable and/or reconfigurable. This further increases the flexibility and robustness of the apparatus. For example, the storage units can be continually rearranged to make the units more accessible and to make optimal use of the available space.

The apparatus may be for storing body tissue cryogenically. The apparatus may further comprise a cryogenic freezer in thermal communication with the storage units and configured to cryogenically freeze the contents of the storage units.

In accordance with another aspect of the present invention, there is provided a method for processing body tissue comprising the steps of:
providing a portion of body tissue;
dividing the body tissue into a plurality of pieces; and
storing the pieces cryogenically, wherein each piece is stored in a separate chamber or storage unit.

The method may further comprise infusing the body tissue with a cryoprotectant before dividing the body tissue into a plurality of pieces. The method may further comprise extracting blood from the body tissue before dividing the body tissue into a plurality of pieces. The method may further comprise removing the body tissue from cryogenic storage and thawing the body tissue.

The body tissue may be from a single donor.

The body tissue may be processed using an apparatus according to any aspect of the invention. The dividing may be carried out by the at least one storage unit.

In accordance with another aspect of the present invention, there is provided body tissue which has been processed using an apparatus according to any aspect of the invention or a method according to any aspect of the invention. The body tissue may be umbilical cord tissue. The body tissue may be from a single donor.

### BRIEF DESCRIPTION OF DRAWINGS

The present invention will now be described with reference to the accompanying drawings, in which:

FIG. 1 shows a cross-sectional view of a typical umbilical cord;

FIG. 2 shows a cut-away view of a typical umbilical cord;

FIGS. 3 and 4 show a device for collecting umbilical cord blood;

FIGS. 5A to 5C show apparatuses for storing body tissue cryogenically according to embodiments of the present invention; and

FIGS. 6A to 6G show storage units according to embodiments of the present invention for use with the apparatuses shown in FIGS. 5A to 5C.

### BEST MODES FOR CARRYING OUT THE INVENTION

The present invention relates to an apparatus and method for storing biological tissue containing stem cells, particularly umbilical cord tissue. The tissue is typically stored cryogenically.

The invention involves the cryogenic storage of biological tissue, or body tissue, containing stem cells in such a way that the tissue can be thawed and used flexibly and efficiently. Tissue containing stem cells, such as an umbilical cord or a part thereof, is of huge importance to both research and healthcare, and it is therefore advantageous to be able to store such tissue in a way that allows a selected portion of the tissue to be extracted, thawed and used as desired, whilst the remaining tissue is maintained in cryogenic storage for future extraction and use. Moreover, since methods for preparing tissue for cryogenic storage and extracting stem cells from biological tissue are continually being improved, the fact that a particular portion of tissue containing stem cells can be stored cryogenically until it is required means that the best possible methods of preparation and extraction can be employed. This optimises the post-thaw yield of stem cells from the stored tissue.

Whilst the invention relates to a method and apparatus for storing biological tissue containing stem cells, typically cryogenically, other optional processes which are typically carried before or after cryogenic storage are described in details below. It will be understood by the skilled person that any of the processes described herein can be combined with any of the other processed described herein. However, in one example, the following processes are carried out in the following order:
Extraction of blood from the tissue (e.g. extraction of cord blood if the tissue is an umbilical cord or a portion of an umbilical cord);
Treatment and/or infusion of the tissue with a cryoprotectant;
Incubation of the tissue (typically in a cryoprotectant);
Cryogenic storage;
Thawing of the tissue and extraction and use of stem cells.

Whilst an exemplary order has been described above, the skilled person will understand that any suitable combination of the above steps in any suitable order could equally be used.

Each of the processes described above will now be described in further detail below, with particular emphasis on an apparatus and method for storing tissue, typically cryogenically, according to the present invention.

Cryoprotectants

Before being stored cryogenically, the tissue is typically treated, contacted or infused with a cryoprotectant and then typically incubated in the cryoprotectant. A cryoprotectant is a substance that is provided to tissue before freezing and yields a higher post-thaw survival of viable cells than can be obtained in its absence. Cryoprotectants are well-known in the art and typically protect biological tissue from freezing damage caused by ice formation. Various cryoprotectants may be used according to the invention. Typical cryoprotectants are described below.

Some cryoprotectants permeate the cell membrane and protect the cell from damage during freezing. These permeating cryoprotectants include: glycols such as ethylene glycol, propylene glycol and glycerol; butanediol e.g. 2,3-butanediol; and Dimethyl sulfoxide (DMSO; [CH₃]₂SO). DMSO is a conventional cryoprotectant that is often used to bathe umbilical cord tissue prior to storage in liquid nitrogen. Cryoprotectants typically comprise 5% to 30% (v/v) DMSO, for example 10% (v/v) or 20% DMSO. In one embodiment, the cryoprotectant comprises 10% (v/v) DMSO.

Cryoprotectants are also known that do not permeate the cell membrane, including: Dextran, e.g. Dextran 40; disaccharides such as sucrose or trehalose; percoll; polyethylene glycol (PEG); and polyvinypyrrolidone (PVP).

Combinations of cryoprotectants may be used. For example, the concentration of DMSO required can be reduced if be combined with disaccharides such as trehalose or sucrose (Rodrigues et al, Cryobiology 56(2) April 2008: p144-151). The disaccharide is typically present at 0.1M with 10% DMSO. A mixture of DMSO and Dextran is also known as an effective cryoprotectant, as is a mixture of DMSO and glycerol, and these mixtures can be used according to the invention.

The cryoprotectant may comprise additional components such as plasma, serum or a serum component such as fetal bovine serum (FBS), Bovine Serum Albumin (BSA), or Human Serum Albumin (HSA). The serum or plasma is typically human and, when the tissue is umbilical cord tissue, may be obtained from the mother. In one embodiment, the cryoprotectant comprises autologous serum (from the mother) containing 10% (v/v) DMSO.

In one embodiment, the cryoprotectant is actively infused into body tissue. Active infusion applies a force to the cryoprotectant, to infuse the cryoprotectant actively into the tissue and provide an increased rate of uptake into the tissue compared to the uptake that would occur in the absence of that force. This is in contrast to the passive application of cryoprotectant, which involves soaking, bathing or submerging the tissue in cryoprotectant and which relies on the cryoprotectant simply soaking into the tissue. Active infusion can, for example, refer to the use of a pressure-exerting means to infuse the tissue with a cryoprotectant. For example, the cryoprotectant may be injected or pumped directly into the tissue. Active infusion can be advantageous over passive infusion because cryoprotectants are typically toxic and active infusion reduces the time required for the tissue to be in contact with the toxic cryoprotectant. The active infusion of the tissue with a cryoprotectant thereby reduces damage to and degeneration of the tissue as a result of incubation with the cryoprotectant, thereby improving the quality of the preserved tissue. In alternative embodiments, however, passive infusion can be used.

One way in which active infusion can be achieved is by injecting cryoprotectant into the tissue. When the cryoprotectant is injected, this may be achieved using a syringe; the syringe may comprise a needle (e.g. a hypodermic needle) or may be a needle-less syringe, typically powered by compressed air or gas.

The treatment or infusion (active or passive) of the tissue with a cryoprotectant is performed at a temperature less than 37° C., i.e. less than body temperature. Typically, the infusion step occurs at between 1° C. and 10° C., more typically between 2° C. and 5° C., for example at approximately 4° C.

Isolated Body Tissue

Any body tissue can be prepared for cryogenic storage according to the invention. The tissue is isolated; in other words, the tissue is no longer part of the human or animal body (the tissue is ex vivo). The tissue is isolated from the body before the method of the invention takes place. The tissue is typically human body tissue. The tissue is typically soft tissue. The body tissue typically contains adult stem cells. The stem cells are typically mesenchymal stem cells. Alternatively, the stem cells may be haematopoietic stem cells or neural stem cells.

The tissue is typically processed within about 24 hours from the time is it removed from the body, more typically within 12 hours. In one embodiment, the tissue is processed and stored without delay, for example within one hour of being removed from the body, or within 30 minutes of being removed from the body.

Suitable body tissues include the umbilical cord, placenta and the amniotic membrane.

Preparation of Umbilical Cord Tissue for Cryogenic Storage

An exemplary tissue that can be prepared for cryogenic storage according to the invention is umbilical cord tissue. Typically, the umbilical cord tissue is postpartum tissue that has been removed (e.g. cut) from the infant.

Long-term storage of the umbilical cord tissue is desirable because mesenchymal stem cells have been identified throughout the umbilical cord, including in the sub-endothelial layer of the umbilical vein and arteries, and in the Wharton's jelly (in particular the perivascular Wharton's jelly). Umbilical cord MSCs are obtained from term umbilical cord after parturition, and are not embryonic stem cells. Umbilical cord MSCs are not capable of developing into an embryo. Obtaining and using umbilical cord blood MSCs does not involve the destruction of human embryos, and obtaining umbilical cord MSCs avoids the controversy and ethical considerations surrounding the provision and use of human embryonic stem (ES) cells.

The umbilical cord tissue may comprise at least a portion of an umbilical cord, for example at least a portion of an umbilical cord vein, a portion of an umbilical cord artery or Wharton's jelly. Typically, the body tissue is an intact piece of umbilical cord, i.e. that has not been divided into its constituent parts, by mechanical or enzymatic means. Intact umbilical cord tissue comprises the umbilical cord vein, two umbilical cord arteries and the Wharton's jelly, surrounded by amniotic epithelium. In one embodiment, intact umbilical cord tissue has not been dissected, cut into pieces or minced.

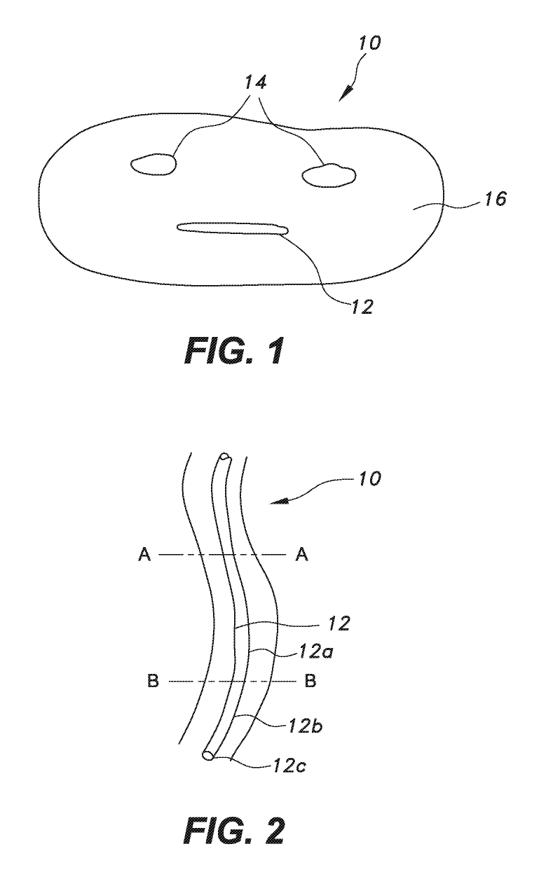

FIG. 1 shows a cross-sectional view of a typical umbilical cord 10. The cord 10 comprises an umbilical cord vein 12 which carries oxygenated blood to a foetus, two umbilical arteries 14 which carry deoxygenated blood from the foetus, and Wharton's jelly 16 which is a gelatinous substance that protects and supports the vein 12 and arteries 14. FIG. 2 shows a perspective view of the same umbilical cord 10 which has been cut-away to show the location of the umbilical cord vein 12.

The entire umbilical cord may be prepared for cryogenic storage. Alternatively, a section of the intact cord tissue may be prepared for storage. A section may be obtained by make a sectional cut along the lines A-A and B-B shown in FIG. 2, and then removing the desired section of umbilical cord tissue from the umbilical cord 10. This section comprises intact umbilical cord tissue: the vein, both arteries, Wharton's jelly, all surrounded by the epithelium.

Whilst an entire umbilical cord is depicted in FIGS. 1 and 2, the skilled person will understand that isolated parts of the umbilical cord, i.e. the umbilical cord vein 12, umbilical cord arteries 14 and/or Wharton's jelly 16, or indeed any body tissue containing stem cells could equally be prepared for cryogenic storage in the manner described herein.

The storage of intact umbilical cord tissue allows for all of the potentially useful cells, in particular stem cells, to be cryogenically stored without losing yield by extraction prior to freezing. Methods for isolating stem cells from tissues are currently subject to significant variation in yield and so it is beneficial to store the umbilical cord as whole tissue. This cryogenically-stored tissue, or a portion of the cryogenically-stored tissue, can be accessed when needed and the stem cells isolated at that point in time, which may improve the yield and/or functionality of the cells that are obtained.

As discussed above, the cryoprotectant is actively or passively infused into the umbilical cord tissue prior to storage. For example, the cryoprotectant may typically be actively infused directly into the lumen of the umbilical cord vein and/or the lumen of one or both umbilical cord arteries. Alternatively or additionally, the cryoprotectant may be actively infused across the amniotic epithelium that forms the outer layer of the umbilical cord, so that the cryoprotectant is infused directly into the umbilical cord tissue (i.e. directly into the Wharton's jelly and/or vasculature).

In one embodiment, an intact umbilical cord is placed into a cryoprotectant bath comprising 10% (v/v) DMSO, at 4° C. for passive infusion with the cryoprotectant. Alternatively or additionally, cryoprotectant comprising 10% (v/v) DMSO is actively infused into the umbilical cord vein or artery lumen. The cryoprotectant may optionally comprise autologous serum or plasma (from the mother).

The tissue (e.g. cord) which has been treated with cryoprotectant is then incubated. If passive infusion alone is used, the cord is typically incubated in the cryoprotectant for 40 minutes at 4° C. before being cryogenically frozen. If active infusion is used in combination with passive infusion, the cord is typically incubated in the cryoprotectant for less than 40 minutes, for example for 10 to 20 minutes, at 4° C., before being cryogenically frozen.

Typically, actively infusing a portion of body tissue with cryoprotectant, as opposed to simply submerging this tissue in cryoprotectant, means that interior portions, concealed portions, or difficult to access portions of the body tissue can be infused with cryoprotectant effectively and efficiently resulting in optimal post-thaw stem cell extraction. Moreover, the active infusion of portions of the body tissue, such as an umbilical vein, which are concealed, hidden or difficult to access (e.g. the interior of the umbilical cord vein) means that incubation times can be reduced significantly when compared with simply submerging or “soaking” the whole tissue umbilical cord vein, or other body tissue, in a cryoprotectant.

Once the cord tissue 10 or other tissue has been infused with cryoprotectant, the entire cord tissue 10 is placed in a suitable receptacle (e.g. an incubator, typically a polypropylene container that is suitable for cryogenic storage) and partially or wholly submerged and soaked in another quantity of cryoprotectant, which can be the same cryoprotectant used for passive and/or active infusion or a different cryoprotectant. The submerged cord tissue 10 is then incubated. In an exemplary embodiment, the cryoprotectant used for incubation is DMSO, for example 5% DMSO or 10% DMSO, in which case the tissue is incubated at 1° C.-10° C., typically 2° C.-5° C., and more typically 4° C. However, the skilled person will understand that other cryoprotectants, such as Dextran40 or glycerol, could equally be used. A function of the cryoprotectant is to prevent the formation of ice crystals when the whole tissue is stored cryogenically (i.e. when it is frozen), as ice crystals can damage the tissue and reduce the yield of MSCs which can be obtained from the tissue after the tissue has been thawed.

The skilled person will understand that preferred incubation times may vary. If passive infusion alone is used, the incubation time may be approximately 40 minutes. If active infusion is used in combination with passive infusion, the incubation time can typically be less than approximately 40 minutes, preferably less than approximately 30 minutes, more preferably less than approximately 20 minutes, and more preferably between approximately 10 minutes and approximately 20 minutes.

Once the tissue has been incubated, it is ready for cryogenic storage. Incubation followed by cryogenic storage permits umbilical cord tissue, or other body tissue, to be preserved as whole tissue until it is needed, for example when stem cells present in the tissue need to be extracted. Since the available methods for extracting stem cells from whole tissue are continually being improved, effective storage means that the best possible method for extracting the stem cells can be employed at the time that the tissue and stem cells therein are needed.

Device for Collecting Umbilical Cord Blood Prior to Cryoprotection

When the body tissue is umbilical cord tissue, some or all of the umbilical cord blood may optionally be removed from the cord before cryoprotecting and subsequently storing the tissue cryogenically. For example, the cord blood may first be harvested for (separate) storage, and the cord which is substantially free of cord blood (but may of course comprise a residual amount of cord blood cells) then prepared for cryopreservation according to the invention. In this way, the cord blood and cord tissue can be harvested and stored.

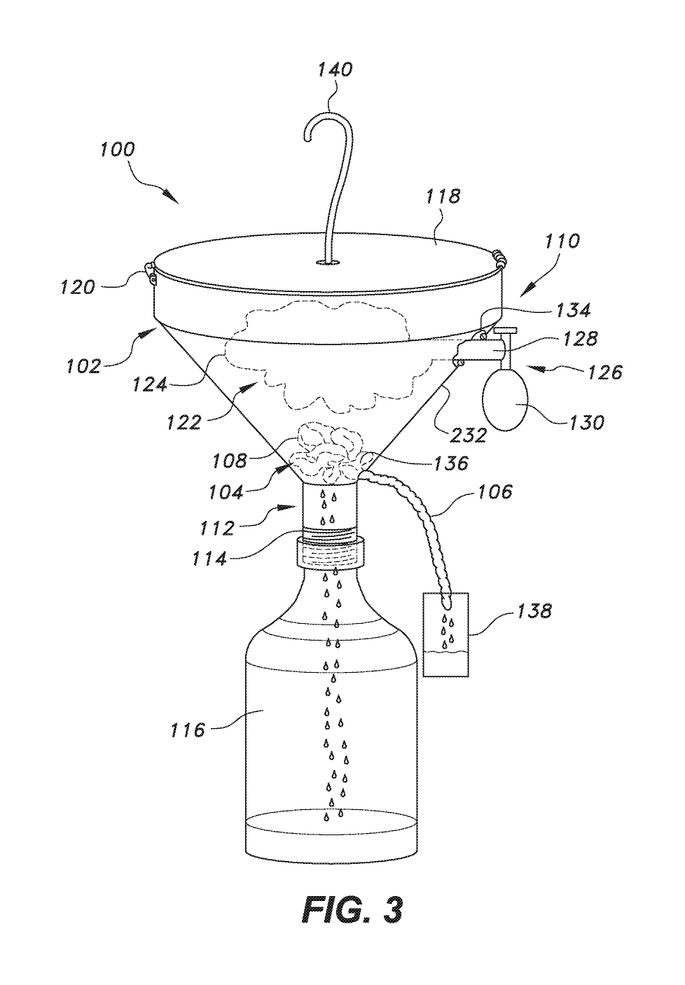

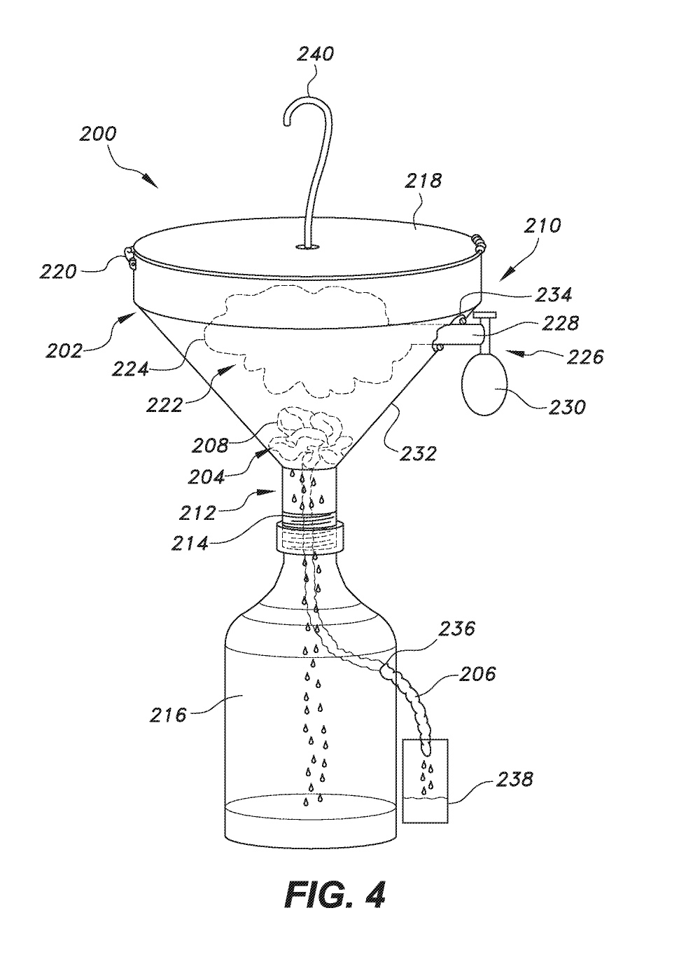

The collection of umbilical cord blood is known in the art and a typical device that can be used to collect the cord blood is described in WO-A-2014/057353 (Virgin Health Bank QSTP-LLC, incorporated herein by reference). Exemplary devices of this kind are shown in FIGS. 3 and 4, below. This device comprises a housing configured to receive a blood source and a first collection means in communication with the housing, wherein the housing comprises a first output configured to allow passage of blood extracted from the blood source and/or at least a portion of the blood source therethrough. The device may be configured to allow for collection of blood from the blood source using a gravitational force. The first output of the device may be configured to allow passage of waste from the blood source therethrough, and the device may further comprise a second output configured to allow passage of at least a portion of the umbilical cord therethrough. By providing separate outputs for the waste and the blood source, waste can be easily separated from useful products. For example, when the blood source is an umbilical cord and placenta, a portion of the cord can be fed through the second output and umbilical cord blood can be collected. Waste from the placenta and cord can be passed through the first output and collected for disposal. A first collection means may be in communication with the housing via the first output. The first collection means may threadingly or pushingly engage the housing at the first output. The device may further comprise a second collection means in communication with the second output; the housing may comprise the second output. The device may further comprise a pressure-exerting means configured in use to exert pressure on the blood source. The provision of a pressure exerting means allows pressure to be exerted on the blood source to force blood out of the blood source effectively and efficiently. At least a portion of the pressure-exerting means may be located within the housing. The pressure-exerting means may comprise an inflatable located within the housing and an inflation means in communication with the inflatable which may extend outside the housing, wherein the inflation means may comprise a conduit configured to transfer fluid, for example, from outside the housing into the inflatable to inflate the inflatable thereby exerting pressure on the blood source.

Once the blood has been collected using a cord blood collection device, the cord tissue can be infused with a cryoprotectant and then incubated, as described above. Optionally, the umbilical cord is removed from the cord blood collection device before it is infused with cryoprotectant. Once the cord tissue has been infused with the cryoprotectant and incubated, it can be stored cryogenically as described below.

In one embodiment, the umbilical cord remains in the cord blood collection device while the infusion step is carried out. In this way, the umbilical cord can be placed in the device and the cord blood harvested, and then the umbilical cord can be infused while connected to the device. This provides a simple method for harvesting both umbilical cord tissue and umbilical cord blood.

As explained above, some or all of the umbilical cord blood may optionally be removed from the cord before performing the active infusion of cryoprotectant according to the present invention. FIGS. 3 and 4 show devices that may be used to harvest the cord blood.

FIGS. 3 and 4 show configurations of a blood-collecting device 100, 200. The device comprises a housing 102, 202 configured to receive a blood source 104, 204. In the figures, the blood source 104, 204 is an umbilical cord 106, 206 and placenta 108, 208 which have previously been detached from a human body.

The housing 102, 202 shown in the figures has a substantially conical portion 108, 208 and generally takes the form of a funnel i.e. having a wide portion at a top end 110, 210 of the housing 102, 202 and tapering gradually inwards to a narrow bottom end 112, 212 of the housing 102, 202. The skilled person will understand that a housing having any other suitable shape (e.g. frustoconical, bowl-shaped, cylindrical) could equally be used. The housing 102, 202 comprises a first output 114, 214, which takes the form of a gap or hole located at the narrow end of the housing 102, 202. Alternatively, the first output 114, 214 can be a removable cover, a permeable membrane, a thinning, or any other output through which a blood source and/or waste from a blood source could pass. In some embodiments, the housing is movable between a deployed configuration and a collapsed configuration, for example, in a concertinaing manner.

A first collection means 116, 216 is in communication with the housing 102, 202 via the first output 114, 214. FIGS. 3 and 4 show the first collection means 116, 216 in threaded engagement with (i.e. screwed onto) the housing 102, 202 at the first output 114, 214. The first collection means 116, 216 can alternatively pushingly engage the housing 102, 202 at the first output 114, 214. A closure 118, 218, such as a lid and/or membrane, is also provided to close or seal the housing 102, 202. In some embodiments, the closure 118, 218 is hingedly attached to the housing 102, 202 and/or releasably attached to the housing 102, 202 by means of a latch or clip 120, 220. The first collections means 116, 216 can, for example, take the form of a wind sock, a flask, or any other suitable bag or container.

The device also comprises a pressure-exerting means 122, 212, at least a portion of which is contained within the housing 102, 202. The pressure-exerting means 122, 212 shown in FIGS. 3 and 4 comprises an inflatable, such as an inflatable sack 124, 224, located within the housing 102, 202 and an inflation means 126, 226 in communication with the inflatable 124, 224 and extending outside the housing 102, 202. The inflatable can alternatively be an inflatable balloon, inflatable pouch, or any other inflatable. The inflation means 126, 226 comprises a conduit 128, 228 configured to transport fluid from outside the housing 102, 202 into the inflatable 124, 224 to inflate the inflatable. The inflation means also optionally comprises a pump 130, 230 located outside the housing 102, 202 and in communication with the conduit 128, 228, wherein the pump 130, 230 is configured to force fluid through the conduit 128, 228 and into the inflatable 124, 224. The figures show the conduit 128, 228 passing through a wall 132, 232 of the housing 102, 202. However, the skilled person will understand that the conduit can also pass through the housing closure 118, 218 or any other portion of the housing 102, 202. It is desirable to ensure a tight seal between the conduit 128, 228 and the closure or housing. A grip or stopper 134, 234, for example a rubber grip or stopper, surrounding the conduit 128, 228 and engaging with the closure or housing can be provided to ensure that an airtight and sterile environment is maintained within the housing 102, 202.

The fluid used to inflate the inflatable 124, 224 may be a gas, such as air, in which case the inflatable can be an airbag and the pump can be an air pump. Alternatively, a liquid, such as water, can be used to inflate the inflatable 124, 224.

As described above, the housing 102, 202 comprises a first output 114, 214. In the exemplary embodiments shown in the figures, the first output is configured to allow passage of waste from the blood source 104, 204 therethrough. The device 100, 200 also comprises a second output 136, 236, which is configured to allow passage of at least a portion of the blood source 104, 204 therethrough. For example, if the blood source is an umbilical cord 106, 206 and/or placenta 108, 208, the second output 136, 236 is configured to allow passage of the umbilical cord 106, 206 therethrough, meaning that umbilical cord blood passes along or through the umbilical cord, through the second output 136, 236. A second collection means 138, 238 is provided to collect the blood extracted from the blood source. The second collection means 138, 238 is typically a bag or flask, although any other suitable collection means can equally be used.

In the configuration shown in FIG. 3, the housing 100 comprises the second output 136.

In the configuration shown in FIG. 4, the first collection means 216 comprises the second output 236. In other words, the umbilical cord 206 is passed through the first output 214 into the first collection means 216, and is then passed through the second output 236 and into the second collection means 238.

In both configurations shown in the figures, the second output is smooth and rounded without any sharp edges so as not to risk tearing the umbilical cord and spilling umbilical cord blood. The second output is a gap or hole on a wall of the housing through which an umbilical cord can pass. Alternatively, the second output is a thinning or a removable cover.

An exemplary method of using the device 100, 200 to harvest cord blood will be described with reference to the figures. The closure 118, 218 is moved to an open position or removed from the housing 102, 202, and a blood source 104, 204, such as an umbilical cord 106, 206 and/or a placenta 108, 208 is placed into the housing 102, 202. The umbilical cord 106, 206 is passed through the second output 136, 236 so that an end of the umbilical cord extends outside the housing. In some embodiments (not shown), a cord clamp is attached to the umbilical cord, in which case the first and/or second output is sufficiently large to allow passage of a cord clamp therethrough. If the device shown in FIG. 3 is used, the umbilical cord 106 is passed directly through the second output 136 into the second collection means 138. If the device shown in FIG. 4 is used, the umbilical cord 206 is passed through the first output 214 into the first collection means 216, and is subsequently passed through the second output 236 into the second collection means 238. In both configurations, the placenta 108, 208 remains within the housing 102, 202 with the inflatable 124, 224 of the pressure-exerting means. The skilled person will understand that the pressure-exerting means is an optional feature, and that gravity on its own will, in many cases, be sufficient to allow for the extraction of umbilical cord blood from the umbilical cord and/or placenta.

Once the blood source is correctly arranged, the closure 118, 218 is moved to its closed position and the latch or clip 120, 220, if provided, is secured to retain the closure on the housing 102, 202. The first collection means 116, 216 is connected to (e.g. screwed onto or pushed onto) the housing 102, 202 at the first output 114, 214 and the second collection means 138, 238 is arranged near the second output 136, 236. For example, the second collection means 138, 238 may be connected to (e.g. screwed onto or pushed onto) the housing 102, 202 at the second output 136, 236. The umbilical cord 106, 206 may be inserted into the second collection means 138, 238 so as to minimise spillage of umbilical cord blood.

Once the device has been assembled, the inflatable 124, 224 is inflated, for example using the pump 130, 230. As the inflatable 124, 224 expands, it exerts pressure on the blood source within the housing, thereby forcing blood out of the blood source. In the device 100 shown in FIG. 3, blood passes from the placenta 108 and through and/or along the umbilical cord 106, out of the second output 136, and into the second collection means 138 for storage. In the device 200 shown in FIG. 4, blood passes from the placenta 208 and through/along the umbilical cord 206, through the first output 214 into the first collection means 216 (but remaining within the umbilical cord), and then out of the second output 236 and into the second collection means 238 for storage.

In the embodiment shown in FIG. 3, the first output 114 is configured to allow passage of waste tissue and/or fluid from the placenta and/or umbilical cord therethrough. This waste then passes into the first collection means 116 and is disposed of.

In the embodiment shown in FIG. 4, the first output 214 is configured to allow passage of the umbilical cord and waste tissue and/or fluid from the placenta and/or umbilical cord therethrough. The umbilical cord then passes out of the first collection means 216 through the second output 236, leaving the waste in the first collection means 216 for disposal.

It is advantageous for the device 100, 200 of the present invention to be mountable on a piece of medical equipment e.g. hospital equipment or furniture. To facilitate mounting of the device, a retaining means 140, 240 in the form of a hook or hanger can optionally be provided on the device.

It is also advantageous for the device to be disposable, so that it can be supplied to medical institutions and/or practitioners as a single-use, easy to use kit e.g. single-use, non-reusable.

Apparatus and Method for Cryogenic Storage of Tissue

As discussed above, it is advantageous to provide an apparatus and method for cryogenically storing whole body tissue, such as umbilical cord tissue, so that tissue from a particular donor can be divided and assigned to different purposes. For example, when whole umbilical cord tissue is extracted from a single donor (i.e. a single person or family), it may be advantageous to assign a portion of the tissue to “community” use and another portion to “private” use.

Private tissue is stored for use solely by the person who was the source of the tissue (the donor) or by another person with the permission of the donor or the donor's guardian or family. Community tissue is stored for use by one or more third parties (who are unconnected to the donor); in other words, community tissue is effectively donated upon storage. In this respect, and throughout this application, “community” and “private” have these definitions.

For the reasons described above, an embodiment of the present invention relates to an apparatus and method for storing biological tissue, typically cryogenically. In the present invention, the flexibility required for tissue from a particular donor to be divided and assigned to different purposes is typically achieved by providing a storage means (e.g. a storage unit or a plurality of storage units) which can be divided (e.g. by detachment) into a number of separate portions, each containing a portion of the stored tissue. This aspect of the invention will now be described in further detail.

Cryogenic storage is well known in the art and involves storing the tissue at very low temperatures, typically using a cryogenic substance such as liquid nitrogen, liquid air, liquid natural gas, liquid carbon dioxide or any other cryogen. Cryogenic storage is typically at a temperature lower than −150° C., more typically lower than −196° C. (which is the boiling point of liquid nitrogen). Typically, the body tissue and cryoprotectant are placed in a storage unit made of a non-brittle sterilisable polymer such as polypropylene. This storage unit is then frozen in a cryogen such as liquid nitrogen, where it is retained until needed. The cryogen is provided in a cryogenic element, such as a cryogenic freezer.

Cryogenic freezing allows for long-term storage of body tissue containing stem cells. This long-term storage is typically for at least one year, more typically at least five years and yet more typically at least ten years. Storage for at least 15 years or at least 20 years, for example at least 25 years or at least 50 years is also within the scope of the phrase “long-term”.

The body tissue is typically prepared for cryogenic storage, typically long term cryogenic storage, by applying a cryoprotectant to the tissue, as described above. In one embodiment of the present invention, the container in which the body tissue is incubated (by bathing or submerging in cryoprotectant) for less than 40 minutes and typically 10 to 20 minutes, is the storage unit in which the tissue is cryogenically frozen. The tissue typically contains stem cells, which are usefully stored long-term so that viable stem cells can be accessed when needed, for example when needed for regenerative medicine, to treat the donor or family member (private use) or other allogeneic person (community use). Moreover, if the body tissue is contained in a storage unit having a seal displaying information about the tissue therein, appropriate tissue can be identified for use with a certain patient or for a certain purpose (e.g. private/community use).

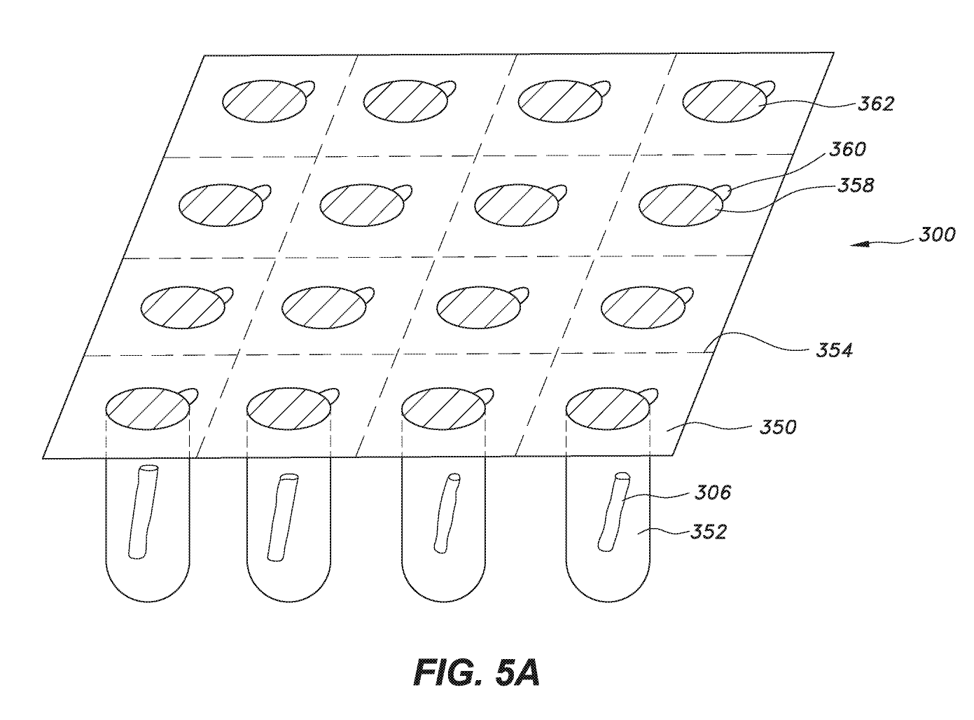

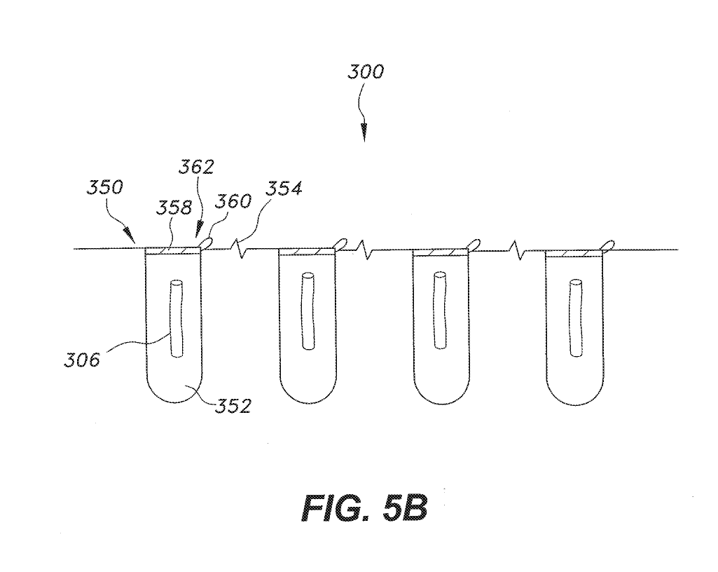

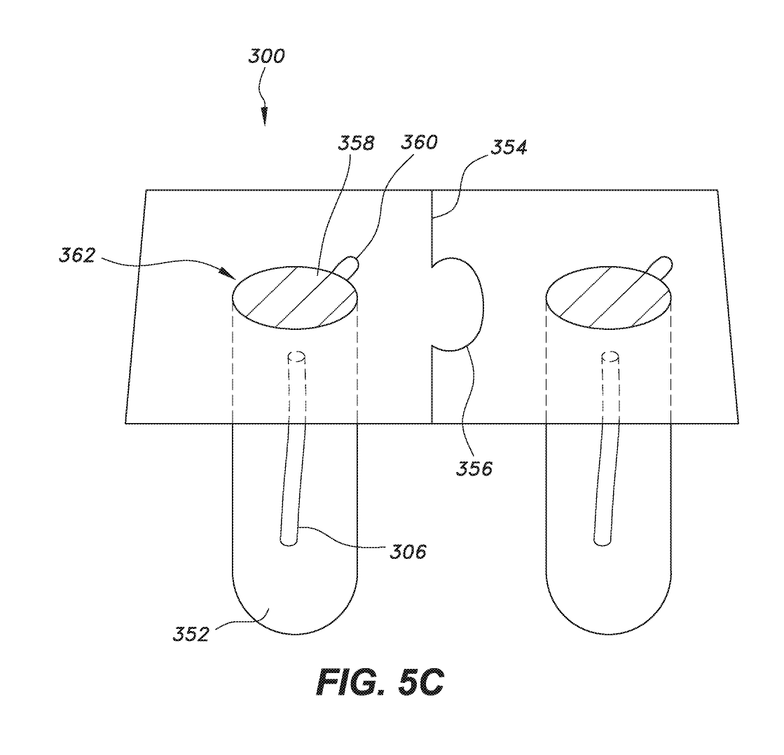

FIG. 5A shows a perspective view of an apparatus 300 for storing body tissue 306 cryogenically according to an embodiment of the invention. FIG. 5B shows a side-on view of a portion of the same apparatus 300. The apparatus 300 comprises a plurality of storage units 350, each storage unit 350 comprising a cavity 352 configured to receive a portion of body tissue 306. In the embodiment shown in the figures, the body tissue 306 is whole umbilical cord tissue. However, as described above, any suitable body tissue can be stored cryogenically according to the invention. For example, the tissue 306 may be umbilical cord tissue and may comprise at least a portion of an umbilical cord, for example at least a portion of an umbilical cord vein, a portion of an umbilical cord artery or Wharton's jelly.

The storage units 350 are detachably connected to one another via a detachable connection 354. The detachable connection 354 can be a reattachable detachable connection or a single-use detachable connection. In the exemplary embodiment shown in FIGS. 5A and 5B, the detachable connection 354 is achieved by means of a frangible, perforated or weakened connection which can be snapped off along the line of the connection 354 to detach one or more storage unit(s) 350 from one or more other storage unit(s) 350. Whilst FIG. 5A shows a two-dimensional array of storage units 350, the skilled person will understand that a one-dimensional array (i.e. a single row) of storage units 350 could equally be used. Moreover, in the three-dimensional array shown in FIG. 5A, it is possible to detach one or more whole row(s) of storage units 350 from the remaining one or more row(s).

In an exemplary embodiment, the storage units 350 are made from polypropylene. Alternatively, the storage units 350 could be made from polyethylene or any other material which is suitable for cryogenic storage. In some embodiments, the storage unit 350 is the same container in which the body tissue 306 was infused with cryoprotectant (actively and/or passively) and/or incubated, as described above.

Whilst the exemplary embodiment shown in FIGS. 5A and 5B comprises frangible, detachable connections 354 between storage units 350, the skilled person will understand that any suitable detachable connection 354 could equally be used. For example, the detachable connection 354 could be formed by an interlocking or “jigsaw” connection 356 formed by complimentary shapes on neighbouring storage units as shown in FIG. 5C. Such interlocking connections 356 may, in some embodiments, comprise an interference fit to strengthen the connection between neighbouring storage units 350. Interlocking connections 356 between neighbouring storage units 350 allow storage units 350 to be detached, reattached and/or reconfigured as desired. This increases the flexibility of the apparatus, particularly in laboratory environments in which storage space is limited.

In alternative embodiments, the detachable connection 354 between storage units 350 shown in FIGS. 5A and 5B could be achieved by means of an adhesive, or by means of a separate attachment means such as adhesive tape, screws or any other attachment means.

In the embodiment shown in FIGS. 5A and 5B, the cavities 352 extend in substantially the same direction (i.e. they extend parallel to one another) thereby creating a neat and compact arrangement. As mentioned above, storage space in laboratories in which tissue samples are stored cryogenically is often limited, and cryogenic containers are costly, meaning that such space-saving is highly desirable. Alternatively, however, the cavities 352 may extend in different directions if required, and any other suitable arrangements will be contemplated by the skilled person depending on the space and/or materials available.

As shown in FIGS. 5A and 5B, whole body tissue 306, such as umbilical cord tissue which has been prepared (i.e. infused with cryoprotectant and incubated) as described above, can be placed into the cavity 352 of a storage unit 350 for cryogenic storage. The arrangement of a plurality of storage units 350 in a row or array makes the apparatus 350 of the invention ideal for storing a plurality of tissue samples neatly such that they are easily accessible. In one embodiment, each storage unit 350 simply stores an entire sample (e.g. a whole umbilical cord or a portion thereof) from a single source (i.e. person) such that the tissue extracted from a single source is contained within a single storage unit 350. However, the apparatus 350 of the invention can be used more flexibly than this. For example, a tissue sample (e.g. umbilical cord) which has been treated as described hereinbefore can be divided into a plurality of pieces, and each piece can be placed into a separate storage unit 350. For example, an umbilical cord can be divided into a plurality of pieces by taking a sectional cut as shown in FIG. 2. Alternatively, components of an umbilical cord, such as the vein, arteries and Wharton's jelly, can be isolated and stored cryogenically in separate storage units 350. The pieces of umbilical cord can be the same size or can vary in size.

The capability of the apparatus 350 of the invention to store pieces of umbilical cord from a particular source flexibly in a plurality of easily-accessible and connected storage containers means that different samples from a single source may be assigned to different purposes, and the proportion of tissue assigned to each purpose can be flexibly decided. For example, a given proportion of tissue from a particular sample may be assigned to community use, whilst the remainder may be assigned to private use. The whole tissue can then be stored cryogenically until it is required for its purpose.

On top of this, the fact that the storage units 350 are detachable from one another means that a single storage unit 350 or a plurality of storage units 350 can be removed from cryogenic storage whilst the remaining storage units 350 remain frozen. Therefore, for example, storage units 350 containing tissue required for a particular purpose (e.g. private use) can be removed from cryogenic storage whilst storage units 350 containing tissue from the same source but required for a different purpose (e.g. community use) can remain in cryogenic storage. In other words, a chosen amount of frozen tissue can be removed from cryogenic storage, thawed, and used as required. In embodiments where the storage units are rearrangeable and reattachable to one another, the storage units 350 which remain in cryogenic storage can be rearranged and/or reattached so as to make optimum use of the space available and organise the remaining samples for easy access.

Referring again to FIGS. 5A and 5B, each storage unit 350 comprises a seal 358 for sealing its cavity 352. The seal 358 may be constructed from a rigid material or from a flexible material. In exemplary embodiments, the seal 358 is constructed from the same material as the storage unit 350. For example, the seal may be constructed from polypropylene or, alternatively, polyethylene. The seal 358 may also be bonded to the storage unit 350 or affixed thereto using an affixing means, such as an adhesive. In the exemplary embodiment shown in FIGS. 5A and 5B, the seal is affixed to a rim of the storage unit by means of an adhesive, and comprises a pull tab 360 which can be gripped by a user and pulled to remove the seal 358 from the storage unit 350 and expose the contents of the cavity 350. The seal 358 may be reusable (i.e. reattachable) or single use (i.e. not reattachable). Single use, or disposable, storage units can be advantageous as they can be provided to medical institutions and discarded safely and cleanly after use. Reusable storage units can be advantageous since they allow for the same storage units to be used on multiple occasions, reducing the cost of purchasing new equipment and minimising damage to the environment. Moreover, reusable or reattachable seals 358 allow just a portion of the tissue 306 within a single storage unit 350 to be removed, thawed and used, whilst the remainder of the tissue 306 within the storage unit 350 remains in cryogenic storage.

In alternative embodiments, the seal 358 may comprise a cork, bung, lid or cap, and may seal the cavity by means of an interference fit. Alternatively, the seal 358 may be attached to the storage unit by means of a screw threaded attachment.

In a preferred embodiment, the seal 358 displays information 362 about the contents of the cavity 352 of the storage unit 350. For example, if the storage unit 350 contains an umbilical cord sample or portion intended for community use, the seal 358 may display this. Similarly, if the storage unit 350 contains an umbilical cord sample or portion intended for private use, the seal 358 may display this. In this way, umbilical cord samples or portions may be identified as being for a particular purpose without a user needing to remove the seal 358 from the storage unit 350. Additionally or alternatively, the seal 358 may display other information about the tissue 306 in the storage unit 350 e.g. information about the source, date of extraction of tissue, date of tissue storage, etc. In a preferred embodiment, the information 362 displayed on the seal 358 is visible whilst the storage unit 350 is in cryogenic storage such that the contents of the storage unit 350 can be identified without requiring the storage unit 350 being removed from cryogenic storage.

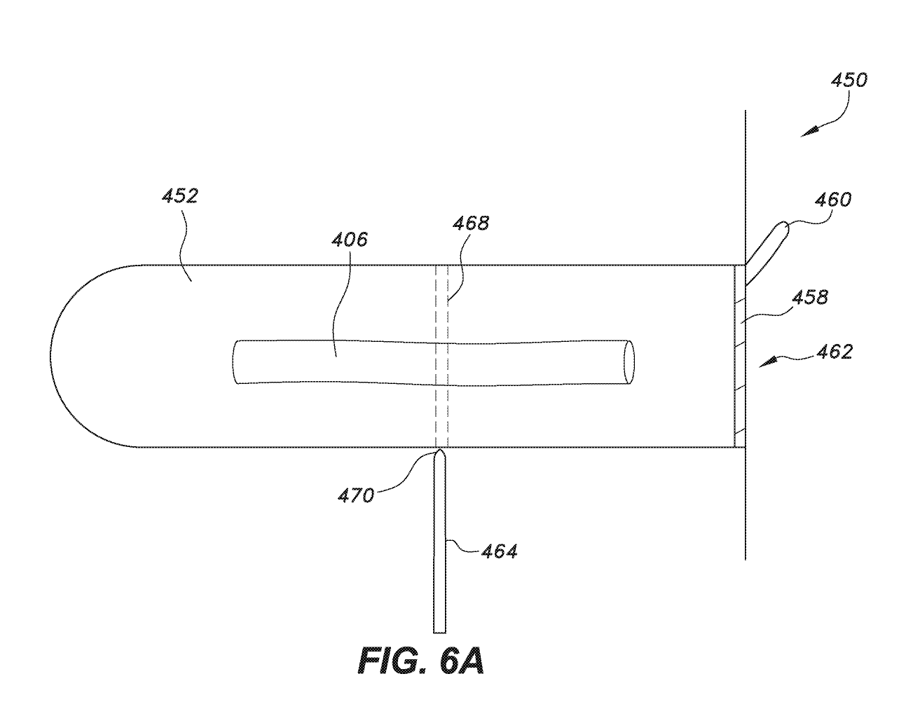

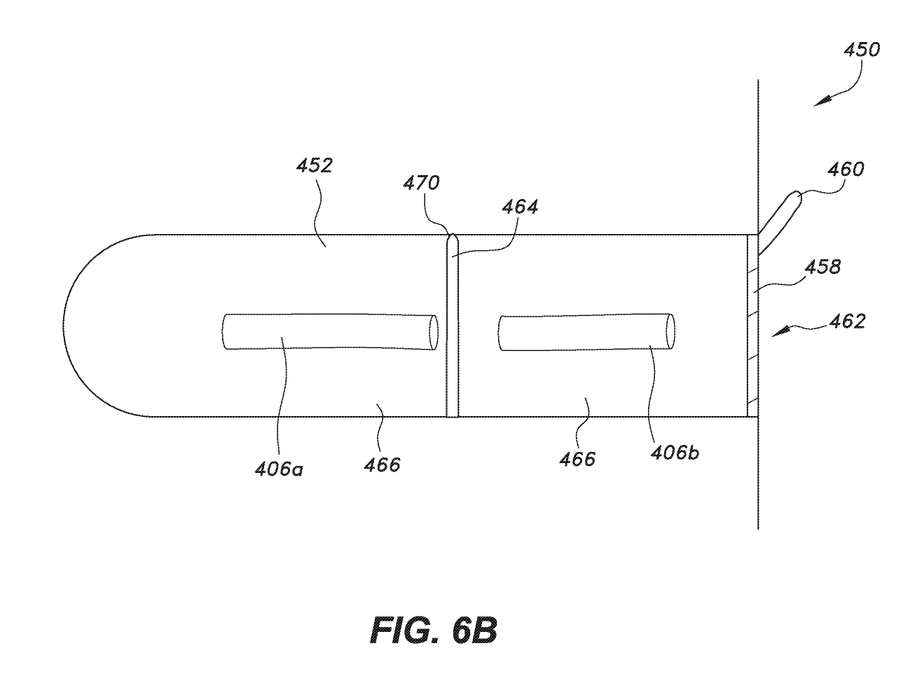

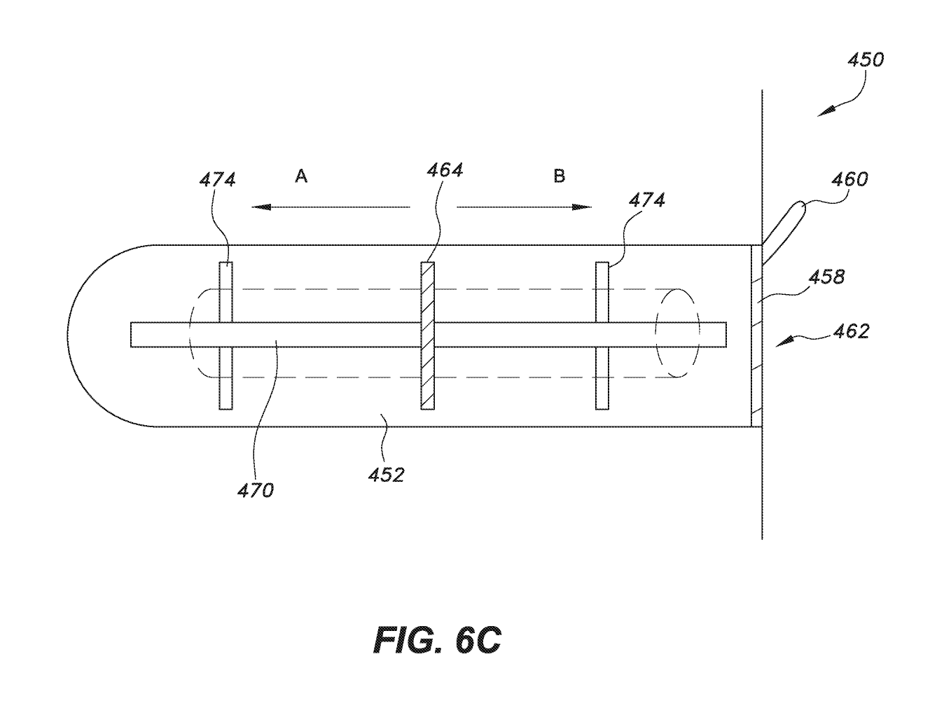

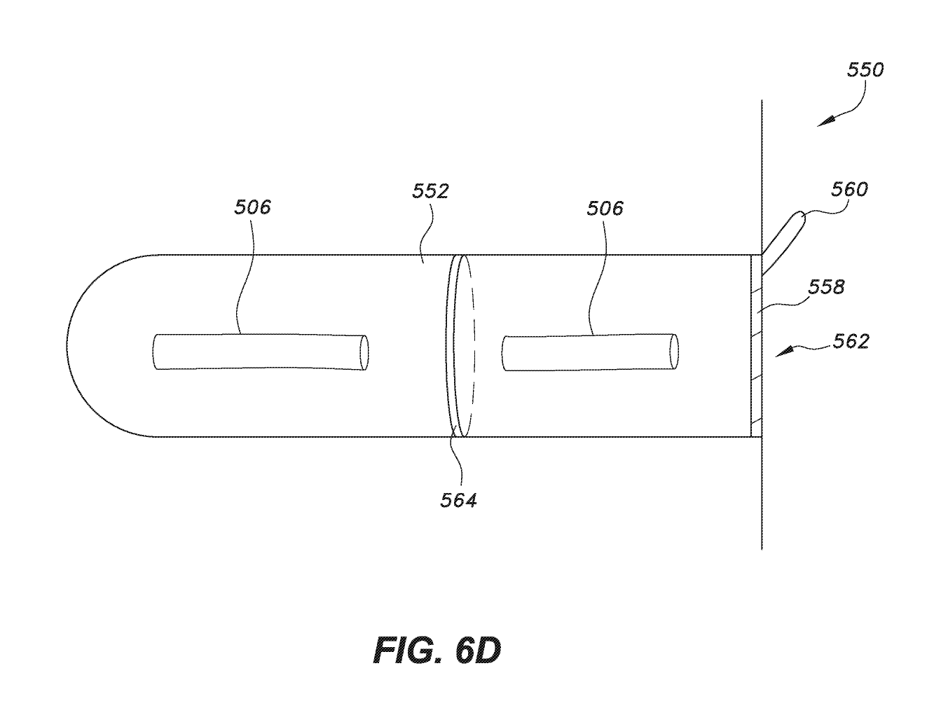

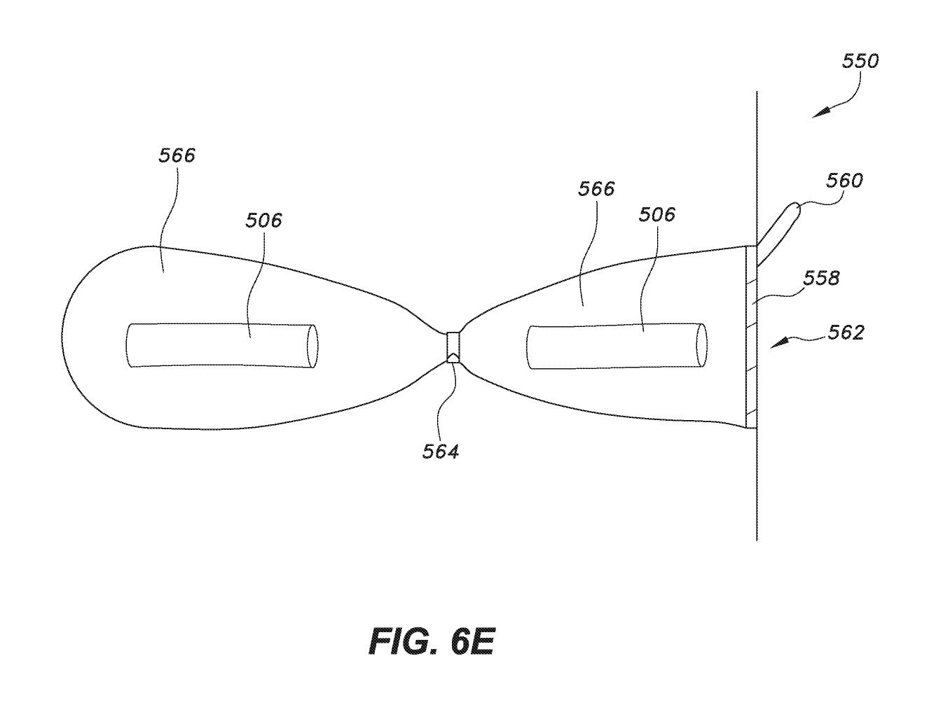

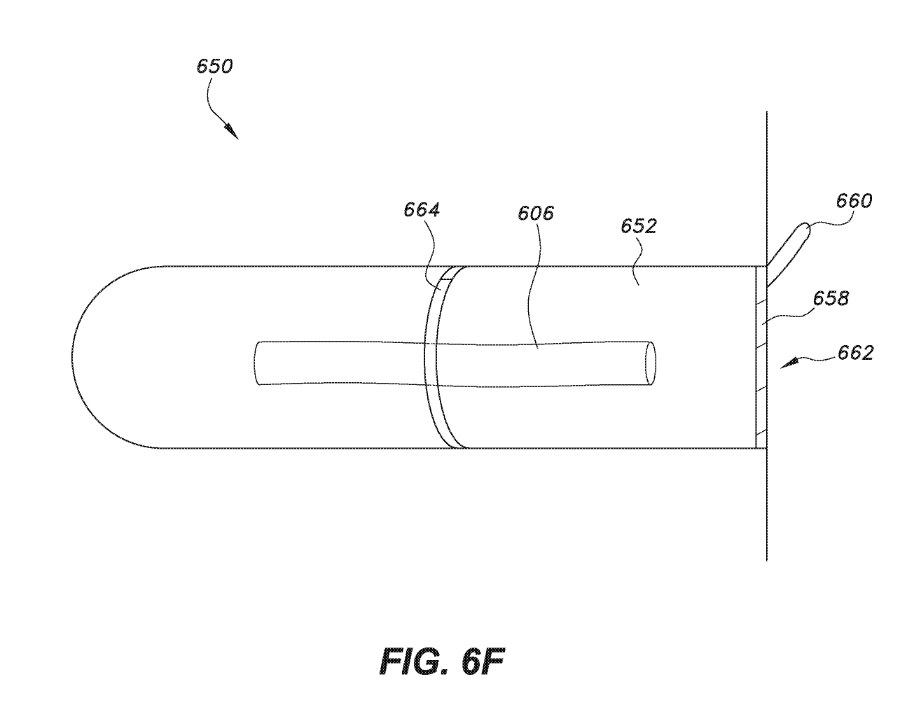

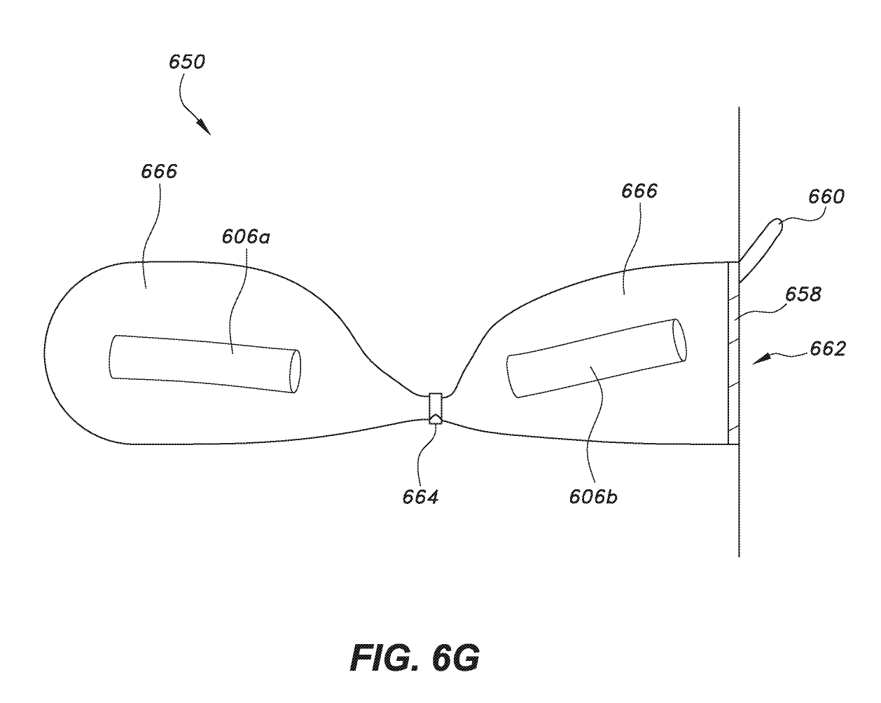

As discussed above, flexibility in storing body tissue containing stem cells for different purposes (e.g. community or private banking) is highly desirable. FIGS. 6A to 6G show storage units according to an embodiment of the invention which can be used independently of, or in combination with, any of the apparatuses 300 described above with reference to FIGS. 5A to 5C to provide a more flexible and robust way of storing body tissue containing stem cells cryogenically.

FIG. 6A shows a storage unit 450 which is capable of dividing a single piece of whole body tissue 406 (e.g. an umbilical cord) from a single source which is intended for a number of different purposes into a plurality of pieces 406a, 406b during cryogenic storage. The storage unit 450 comprises a cavity 452 configured to receive a portion of body tissue 406 and a separator 464 for dividing the cavity 452 into a plurality of chambers 466. In the embodiment shown in FIG. 6A, the separator 464 is a wall which moves slidably within a slot 468 in the storage unit 450 between an inactive configuration in which the separator 464 does not divide the cavity 452 into a plurality of chambers 466 and an active configuration in which the separator 464 divides the cavity 452 into a plurality of chambers 466. The separator 464 has a sharp edge 470 such that it cuts through the body tissue 406 to divide the body tissue 406 into a plurality of pieces 406a, 406b when it moves from its inactive configuration to its active configuration.

FIG. 6A shows the separator 464 in its inactive position. FIG. 6B shows the separator 464 in its active position, and the body tissue 406 has been divided into a plurality of pieces 406a, 406b (e.g. two pieces).

The flexibility of the storage unit 450 shown in FIGS. 6A and 6B can be further improved by providing a separator 464 which slides along a track 472 disposed on the storage unit 450 which extends perpendicularly to the separator 464 itself. Such a storage unit is shown in FIG. 6C. The separator 464 can be moved along the longitudinal axis of the storage unit 450 (i.e. in direction A or B) between a number of inactive positions defined by notches or apertures 474 through which the separator 464 can slide in the same manner as described above with respect to FIGS. 6A and 6B. In this way, a chosen proportion of the body tissue 406 can be removed, thawed and used as required (e.g. for private/community use) whilst the remaining tissue is retained in cryogenic storage. This makes for a highly flexible and robust arrangement through which a specially-selected portion of the body tissue 406 can be removed from cryogenic storage at a given time.

Another embodiment of a storage unit 550 for use with the apparatuses shown in FIGS. 5A and 5B is shown in FIGS. 6D and 6E. The storage unit 550 comprises a cavity 552 which is intended to receive multiple pieces of body tissue 506, particularly multiple pieces 506 of body tissue from a single source. The storage unit 550 comprises a separator 564 in the form of a sealing strip which extends around the perimeter of the storage unit 550. The sealing strip 564 is configured to act as a separator by means of a “press and seal” action in the same way as a traditional plastic sandwich bag, which is well-known to a person skilled in the art. The strip 564 is movable between an inactive configuration in which the strip 564 does not divide the cavity 552 into a plurality of chambers 566 and an active configuration in which the separator 564 divides the cavity 552 into a plurality of chambers 566. FIG. 6D shows the strip 564 in its inactive position. FIG. 6E shows the strip 564 in its active position, and the pieces of body tissue 506 have been divided into distinct chambers 566.

In a further alternative embodiment (not shown), a plurality of strips 564 may be provided along the longitudinal axis of the storage unit 550 such that the relative sizes of the chambers 566 can be selected flexibly.

It is also advantageous for the sealing strip 564 to form a detachable connection. Thus, once the sealing strip 564 has been moved to its active position (FIG. 6E) to divide the cavity 552 into a plurality of chambers 566 thereby isolating one or more pieces 506 from the remaining pieces 506, one of the chambers 566 can be removed such that the pieces 506 therein can be thawed and used, whilst the remaining pieces 506 are retained in cryogenic storage.

A further alternative embodiment of a storage unit 650 for use with the apparatuses shown in FIGS. 5A and 5B is shown in FIGS. 6F and 6G. The storage unit 650 comprises a cavity 652 which is intended to receive a single piece of body tissue 606 or multiple pieces of body tissue 606, particularly multiple pieces 606 of body tissue from a single source or donor. In the example shown in FIG. 6F, the cavity receives a single piece 606 of body tissue. The storage unit 650 comprises a separator 664 in the form of a slider. The slider 664 comprises a track and a zip which is configured to slide within the track in a manner similar to a re-sealable sandwich bag (e.g. a Ziploc™ bag), which is well-known to a person skilled in the art. The slider 664 is movable between an inactive configuration in which the slider 664 does not divide the cavity 652 into a plurality of chambers 666 and an active configuration in which the slider 664 divides the cavity 652 into a plurality of chambers 666. FIG. 6F shows the slider 664 in its inactive position. FIG. 6G shows the slider 664 in its active position.

In an embodiment (not shown) in which multiple pieces of body tissue are contained in the chamber 652 (similarly to the example shown in FIGS. 6D and 6E), the slider 664 can act as a separator to simply divide the cavity 652 into multiple chambers with the pieces of body tissue divided between the chambers.

However, as shown in FIG. 6G, in some embodiments, the slider 664 is sufficiently strong and sharp that it is able to cut through body tissue 606 to divide the body tissue 606. Thus, much like the example shown in FIGS. 6A and 6B, when the slider 664 is moved from its inactive position (FIG. 6F) to its active position (FIG. 6G), it divides the body tissue 606 into separate pieces 606a, 606b which are contained in separate chambers 666.

In a further alternative embodiment (not shown), a plurality of sliders 664 may be provided along the longitudinal axis of the storage unit 650 such that the relative sizes of the chambers 666 can be selected flexibly.

It is also advantageous for the slider 664 to form a detachable connection. Thus, once the slider 664 has been moved to its active position (FIG. 6G) to divide the cavity 652 into a plurality of chambers 666 thereby isolating one or more pieces 606 from the remaining pieces 606, one of the chambers 666 can be removed such that the pieces 606 therein can be thawed and used, whilst the remaining pieces 606 are retained in cryogenic storage.

The storage units shown in FIGS. 6A to 6G also comprise a seal 458, 558, 658 for sealing the cavity 452, 552, 652. The seal 458, 558, 658 may be constructed from a rigid material or from a flexible material. In exemplary embodiments, the seal 458, 558, 658 is constructed from the same material as the storage unit 450, 550, 650. For example, the seal may be constructed from polypropylene or, alternatively, polyethylene. The seal 458, 558, 658 may also be bonded to the storage unit 450, 550, 650 or affixed thereto using an affixing means, such as an adhesive. In the same way as shown in FIGS. 5A and 5B, the seal is typically affixed to a rim of the storage unit by means of an adhesive, and comprises a pull tab 460, 550, 650 which can be gripped by a user and pulled to remove the seal 458, 558, 658 from the storage unit 450, 550, 650 and expose the contents of the cavity 450, 550, 650. The seal 458, 558, 658 may be reusable (i.e. reattachable) or single use (i.e. not reattachable). Single use, or disposable, storage units can be advantageous as they can be provided to medical institutions and discarded safely and cleanly after use. Reusable storage units can be advantageous since they allow for the same storage units to be used on multiple occasions, reducing the cost of purchasing new equipment and minimising damage to the environment. Moreover, reusable or reattachable seals 458, 558, 658 allow just a portion of the tissue 406, 506, 606 within a single storage unit 450, 550, 650 to be removed, thawed and used, whilst the remainder of the tissue 406, 506, 606 within the storage unit 450, 550, 650 remains in cryogenic storage.

In alternative embodiments, the seal 458, 558, 658 may comprise a cork, bung, lid or cap, and may seal the cavity by means of an interference fit. Alternatively, the seal 458, 558, 658 may be attached to the storage unit by means of a screw threaded attachment.

In a preferred embodiment, the seal 458, 558. 658 displays information 462, 562. 662 about the contents of the cavity 452, 552. 652 of the storage unit 450, 550. 650. For example, if the storage unit 450, 550. 650 contains an umbilical cord sample or portion intended for community use, the seal 458, 558. 658 may display this. Similarly, if the storage unit 450, 550. 650 contains an umbilical cord sample or portion intended for private use, the seal 458, 558, 658 may display this. In this way, umbilical cord samples or portions may be identified as being for a particular purpose without a user needing to remove the seal 458, 558. 658 from the storage unit 450, 550. 650. Additionally or alternatively, the seal 458, 558. 658 may display other information about the tissue 406, 506. 606 in the storage unit 450, 550. 650 e.g. information about the source, date of extraction of tissue, date of tissue storage, etc. In a preferred embodiment, the information 462, 562. 662 displayed on the seal 458, 558. 658 is visible whilst the storage unit 450, 550. 650 is in cryogenic storage such that the contents of the storage unit 450, 550. 650 can be identified without requiring the storage unit 450, 550. 650 being removed from cryogenic storage.

Each of the apparatuses described above with reference to FIGS. 5A to 5C and 6A to 6G is typically designed to be kept sterile and aseptic, and to keep the tissue stored within the apparatus in a sterile and aseptic environment.

Thawing Cryogenically Stored Cells

Methods of thawing cryogenically stored tissue to obtain viable cells, at the time when the tissue and cells are needed, are well-known in the art. Briefly, the tissue is typically thawed in a water bath at between 20 to 40° C., for example 37° C. Once thawed, the tissue is typically transferred to a different container and washed to dilute or remove the cryoprotectant. The washing may be performed using cool (e.g., refrigerated, such as 4° C.) liquid, such as water or buffered saline, e.g., PBS, by immersing the tissue in the cool liquid. Vigorous washing of the tissue is often avoided, so that shock or damage to the cells is minimized The immersed tissue can be retained in a refrigerator for another period to permit further dilution and replacement of the cryoprotectant by water, and then still further diluted by addition of further cooled liquid.

The resulting restored tissue can then be used to recover viable cells, such as stem cells, resident within the tissue, optionally using the known techniques for recovering viable cells from fresh cord tissue.

It should be understood that any of the devices, methods and apparatuses described above can be combined with any of the other devices, methods and apparatuses described above.

The present invention has been described above in exemplary form with reference to the accompanying drawings which represent a single embodiment of the invention. It will be understood that many different embodiments of the invention exist, and that these embodiments all fall within the scope of the invention as defined by the following claims.

1. An apparatus for storing body tissue comprising a plurality of storage units, each storage unit comprising a cavity configured to receive a portion of body tissue, wherein at least one storage unit is detachably connected to at least one other storage unit.

2. An apparatus according to claim 1, wherein at least one storage unit comprises a seal for sealing the cavity.

3. An apparatus according to claim 1 or claim 2, wherein each storage unit comprises a seal for sealing its cavity.

4-15. (canceled)

16. An apparatus for storing body tissue, comprising:
a storage unit comprising a cavity configured to receive a portion of body tissue; and
a separator for dividing the cavity into a plurality of chambers.

17. An apparatus according to claim 16, wherein the separator is movable between an inactive position in which the separator does not divide the cavity into a plurality of chambers ad an active position in which the separator divides the cavity into a plurality of chambers.

18. An apparatus according to claim 16 or claim 17, wherein the separator comprises a wall.

19. An apparatus according to claim 16 or claim 17, wherein the separator comprises a slider.

20-22. (canceled)

23. An apparatus according to claim 16, wherein the separator comprises a sealing strip.

24. An apparatus according to claim 23, wherein the sealing strip is configured to divide the cavity into a plurality of chambers via a press and seal mechanism.

25-36. (canceled)

37. A method for processing body tissue comprising the steps of:
providing a portion of body tissue;
dividing the body tissue into a plurality of pieces; and
storing the pieces cryogenically, wherein each piece is stored in a separate chamber of storage unit.

38. A method according to claim 37, further comprising infusing the body tissue with a cryoprotectant before dividing the body tissue into a plurality of pieces.

39. A method according to claim 37 or claim 38, further comprising extracting blood from the body tissue before dividing the body tissue into a plurality of pieces.

40-51. (canceled)
